(19) United States
(12) Patent Application Publication
(10) Pub. No.: US 2019/0268846 A1
(43) Pub. Date: Aug. 29, 2019

(54) SUSPEND, RESUME, AND TEARDOWN OF TWT SESSIONS AND MEMBERSHIPS

(71) Applicant: QUALCOMM Incorporated, San Diego, CA (US)

(72) Inventors: Yongchun XIAO, San Jose, CA (US); Alfred ASTERJADHI, San Diego, CA (US); Abhishek Pramod PATIL, San Diego, CA (US); Sandip HOMCHAUDHURI, San Jose, CA (US)

(21) Appl. No.: 16/243,008

(22) Filed: Jan. 8, 2019

Related U.S. Application Data
(60) Provisional application No. 62/636,159, filed on Feb. 27, 2018.

(51) Int. Cl. H04W 52/02; H04W 4/06

(52) U.S. Cl. CPC H04W 52/0216; H04W 4/06; H04W 52/0229

(57) ABSTRACT

A method and a system are disclosed for suspending or resuming one or more broadcast-TWT sessions by a first device such as an AP. The method includes the first device obtaining a TWT beacon frame. The method also includes the first device adding one or more TWT information fields to the TWT beacon frame. The method further includes the first device transmitting the TWT beacon to one or more stations to suspend the one or more broadcast-TWT sessions.

### CROSS-REFERENCE TO RELATED APPLICATION(S)

This application claims the priority benefit of U.S. Provisional Application Ser. No. 62/636,159, entitled “SUSPEND, RESUME, AND TEARDOWN OF TWT SESSIONS AND MEMBERSHIPS” and filed on Feb. 27, 2018, which is expressly incorporated by reference herein in its entirety.

### BACKGROUND

### Field

The present disclosure relates generally to communication systems, and more particularly, to methods and apparatus related to suspension, resumption, and teardown of target wake time (TWT) in a wireless network.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices disclosed herein each have several aspects, no single one of which is solely responsible for the desirable attributes. Without limiting the scope of the innovative aspects as expressed by the claims which follow, some features will now be discussed briefly. After considering this discussion, and particularly after reading the section entitled “Detailed Description,” a person having ordinary skill in the art will understand how the various features described herein provide advantages for devices in a wireless network.

Various aspects related to suspension, resumption, and teardown of TWT for user devices of a WLAN network is disclosed. TWT allows individual user devices (STAs) to go into a sleep mode and to wake up at defined intervals to exchange data frames with an access point (AP) or other STAs. The use of TWT centralizes the scheduling of transmit (Tx) or receive (Rx) time for a group of STAs, thus minimizing collisions and saving power in the deployment of a WLAN network, such as one that conforms to the 802.11ax standard. A STA may initiate a request to AP to setup one or more individual-TWT sessions using TWT action frames. Alternatively, the AP may initiate setup of a broadcast-TWT session with a group of STAs using beacon frames. The group of STAs becomes members of the broadcast TWT session and may use TWT parameters of the broadcast-TWT session to go into sleep mode and to wake up. In either individual-TWT or broadcast-TWT sessions, the sessions are sometimes suspended or torn down to free up the channel resources for other purposes and then the sessions are resumed at a later time when the channel resources become available. Current implementations to suspend, teardown, or resume TWT sessions for all the individual-TWT sessions of a STA or for all the broadcast-TWT sessions for all the members of the broadcast-TWT sessions are slow and inefficient. In addition, it may be desirable to suspend, or resume only a subset of the individual-TWT session or a subset of the broadcast-TWT sessions for a STA, or to teardown or re-setup a subset of the members of a broadcast-TWT session. Embodiments of the present disclosure provide the flexibility and efficiency to suspend, teardown, or resume one, some, or all of the individual-TWT or broadcast-TWT sessions for one or more STAs of a WLAN network.

One aspect of this disclosure provides a method for suspend or resume one or more broadcast-TWT sessions by a first device. The method includes the first device obtaining a TWT beacon frame. The method also includes the first device adding one or more TWT information fields to the TWT beacon frame. The method further includes the first device transmitting the TWT beacon to one or more stations to suspend the one or more broadcast-TWT sessions.

### BRIEF DESCRIPTION OF THE DRAWINGS

FIG. 1 shows an example wireless communication system in which aspects of the present disclosure may be employed.

FIG. 2a shows an example format of the TWT information field of a TWT information frame to support the suspension or resumption of one broadcast-TWT session or one individual-TWT session in accordance with techniques described herein.

FIG. 2b shows an example format of the TWT information field of a TWT information frame to support the suspension or resumption of multiple broadcast-TWT sessions or multiple individual-TWT sessions in accordance with techniques described herein.

FIG. 3a shows an example format of the TWT information element of a TWT information frame to support the suspension or resumption of one broadcast-TWT session or one individual-TWT session in accordance with techniques described herein.

FIG. 3b shows an example format of the TWT information element of a TWT information frame to support the suspension or resumption of multiple broadcast-TWT sessions or multiple individual-TWT session in accordance with techniques described herein.

FIG. 4a shows an example format of using one reserved/unused bits of current TWT information field of a TWT information frame to support the suspension or resumption of broadcast-TWT membership in accordance with techniques described herein.

FIG. 4b shows an example format of using one reserved/unused bits of new TWT information element of a TWT information frame to support the suspension or resumption of broadcast-TWT membership in accordance with techniques described herein.

FIG. 5 shows an example format of the TWT information field or TWT information element of a beacon frame to support the suspension or resumption of multiple broadcast-TWT sessions for all member STAs of the sessions in accordance with the techniques described herein.

FIG. 6 shows an example format of a TWT teardown frame to support the teardown of a broadcast-TWT session accordance with the techniques described herein.

FIG. 7a shows an example format of multiple TWT information fields of a TWT information frame to support the suspension or resumption of multiple broadcast-TWT sessions or multiple individual-TWT sessions in accordance with the techniques described herein.

FIG. 7b shows an example format of multiple TWT information fields of a TWT beacon frame to support the suspension or resumption of multiple broadcast-TWT sessions or multiple individual-TWT sessions in accordance with the techniques described herein.

FIG. 8a shows an example format of using the TWT element in a beacon frame to support the suspension or resumption of one or more broadcast-TWT sessions in accordance with the techniques described herein.

FIG. 8b shows an example format of using an All Session bit of a TWT information frame to support the suspension or resumption of all broadcast-TWT sessions in accordance with the techniques described herein.

FIG. 9 is a flowchart showing an example method practiced by a first device to suspend or resume multiple broadcast-TWT sessions for all member STAs of the sessions using a TWT beacon frame in accordance with the techniques described herein.

FIG. 10 is a flowchart showing an example method practiced by a first device to suspend or resume multiple broadcast-TWT sessions for all member STAs of the sessions using the TWT information element of a TWT information frame in accordance with the techniques described herein.

FIG. 11 is a flowchart showing an example method practiced by a first device to teardown a broadcast-TWT session using a TWT teardown frame in accordance with the techniques described herein.

FIG. 12 shows a functional block diagram of an example wireless device configured in accordance with the techniques described herein.

### DETAILED DESCRIPTION

Various aspects of the novel systems, apparatuses, computer-readable media, and methods are described more fully hereinafter with reference to the accompanying drawings. The innovative aspects may, however, be embodied in many different forms and should not be construed as limited to any specific structures or functions presented throughout this disclosure. Rather, these aspects are provided so that this disclosure will be thorough and complete, and will fully convey the scope of the disclosure to enable persons having ordinary skill in the art to practice the innovative aspects. Based on the teachings herein, persons having ordinary skill in the art should appreciate that the scope of the disclosure is intended to cover any aspects of the innovative systems, apparatuses, computer program products (e.g., computer-readable media), and methods disclosed herein, whether implemented independently of, or combined with, any other aspects of the disclosure. For example, an apparatus may be implemented or a method may be practiced using any number of the aspects set forth herein. In addition, the scope of the disclosure is intended to cover such an apparatus or method which is practiced using other structures or functionalities in addition to or other than the various aspects set forth herein. It should be understood that any aspect disclosed herein may be embodied by one or more elements of a claim.

Although particular aspects are described herein, many variations and permutations of these aspects fall within the scope of this disclosure. Although some benefits and advantages of particular aspects are described, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following detailed description. While the detailed description and drawings are illustrative of the disclosure, they are not to be understood as limiting.

Popular wireless network technologies may include various types of wireless local area networks (WLANs). A WLAN may be used to interconnect nearby devices together, employing widely used networking protocols. The various aspects described herein may apply to any communication standard or wireless protocol.

In some aspects, wireless signals may be transmitted according to an IEEE 802.11 standard protocol using orthogonal frequency-division multiplexing (OFDM), direct-sequence spread spectrum (DSSS) communications, or a combination of OFDM and DSSS communications, or other schemes. Implementations of the 802.11 protocol may be used for sensors, metering, and smart grid networks. Advantageously, aspects of some devices implementing the 802.11 protocol may consume less power than devices implementing other wireless protocols, or may be used to transmit wireless signals across a relatively long range, for example, about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP. In this regard, a STA may be described as a virtual AP (which may also be referred to as an AP STA) or a non-AP STA.

As discussed, the various aspects described herein may apply to any communication standard or wireless protocol. For example, in cellular communication (e.g., LTE), an access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile device, a mobile station, a remote station, a remote terminal, a user terminal, a user agent, a user device, a user equipment (UE), or some other terminology. In some implementations, a station may comprise a cellular telephone, a “smartphone,” a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system (GPS) device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatuses followed by an “association response” by the other apparatus. It will be understood by persons having ordinary skill in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of A, B or C” is intended to cover: A, B or C individually, or any combination thereof (e.g., A-B, A-C, B-C, or A-B-C).

As discussed above, some devices described herein may implement an IEEE 802.11 standard, for example, one or more of 802.11a, 802.11b, 802.11g, 802.11n, 802.11ac, 802.11ad, 802.11ah, 802.11ax, 802.11ay and 802.11az. Such devices, whether implemented as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

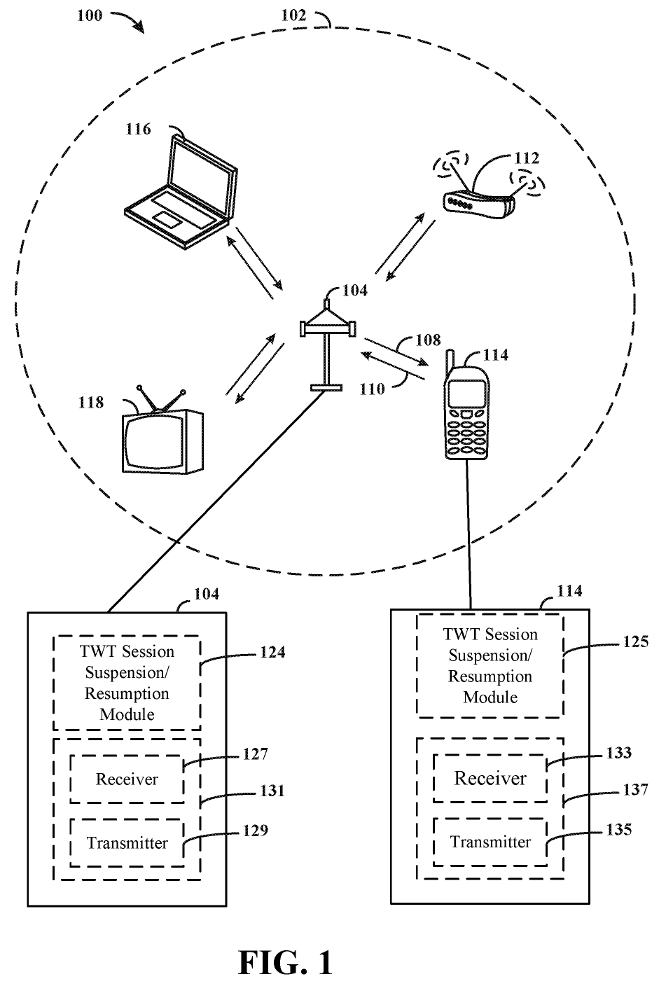

FIG. 1 shows an example wireless communication system 100 in which aspects of the present disclosure may be employed. The wireless communication system 100 may operate pursuant to a wireless standard such as, for example, those described herein. The wireless communication system 100 may include an AP 104, which communicates with STAs (e.g., STAs 112, 114, 116, and 118).

A variety of processes and techniques may be used for the transmission and reception of communications in the wireless communication system 100 between the AP 104 and the STAs, as well as directly between STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 that use the AP 104 for communication may be referred to as a basic service set (BSS). It should be noted that the wireless communication system 100 may not have a scheduling AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link, such as the downlink 108, to other nodes (STAs) of the wireless communication system 100. The beacons may help the other nodes (STAs) to synchronize their clocks with the AP 104, as well as provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 to send communications to and receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN). WiFi devices may currently operate on a set of available frequency bands including one or more of, for example, 2.4 GHz, 5 GHz, 6 GHZ, 900 MHz, or 60 GHz. The 6 GHz band (also referred to herein as 6G) is expected to become available for operation of a next generation of devices including Wi-Fi and Cellular devices (e.g., LTE on unlicensed spectrum).

Generally, the AP 104 (or the STA 114 in another aspect) may include one or more components for performing various functions. The AP 104 includes a receiver 127 and a transmitter 129. The receiver 127 may be configured to perform any receiving function described herein. The transmitter 129 may be configured to perform any transmitting function described herein. The receiver 127 and the transmitter 129 may be combined into a transceiver 131.

For example, the AP 104 may include a target wake time (TWT) session suspension/resumption module 124. In an individual-TWT session, a STA 114 may set up with the AP 104 individually. A flow ID of the individual-TWT session may be used to identify a TWT agreement between the STA 114 and the AP 104. In a broadcast-TWT session, the AP 104 may broadcast TWT beacons to configure the TWT for all member STAs of the broadcast-TWT session. A flow ID of the broadcast-TWT session may be used to specify frame types that can be exchanged with the AP 104. In some aspects, one or more TWT frames exchanged between the AP 104 and/or the STA 114 may include a TWT action frame. A TWT action frame may be associated with an unprotected S1G category or another category related to (e.g., specific to) TWT.

In a broadcast-TWT session, a broadcast-TWT ID may be assigned by the AP 104 to identify the broadcast-TWT session. The AP 104 may one or more broadcast-TWT sessions in beacon frames, which may include TWT parameters used to configure member STAs of the broadcast-TWT session. The AP 104 may use the TWT session suspension/resumption module 124 to suspend, teardown, resume member STAs of the broadcast-TWT session using the TWT beacon frames.

Generally, the STA 114 may include one or more components for performing various functions. For example, the STA 114 may include a TWT session suspension/resumption module 125 to perform procedures related to one or more techniques described herein. The STA 114 also includes a receiver 133 and a transmitter 135. The receiver 133 may be configured to perform any receiving function described herein. The transmitter 135 may be configured to perform any transmitting function described herein. The receiver 133 and the transmitter 135 may be combined into a transceiver 137. The receiver 133 and the transmitter 135 may, respectively, receive signals from, and transmit signals to, the AP 104 or another STA using one or more antenna. For example, the receiver 133 may receive the TWT beacon frames from the AP 104. The transmitter 135 may transmit a TWT information frame from the STA 114 to the AP 104 for the AP 104 to suspend or resume TWT sessions.

In some aspects, one or more apparatuses in a system (e.g., the AP 104, the STA 114, etc.) may be configured to communicate information indicating whether reception of TWT information frames is enabled or disabled. That is, one of the AP 104 or the STA 114 may transmit (e.g., to the other of the AP 104 or the STA 114) a frame including information indicating that the one of the AP 104 or the STA 114 is to no longer receive TWT information frames from the other one of the AP 104 or the STA 114. For example, the AP 104 may signal to the STA 114 that the STA 114 is to refrain from transmission of TWT information frames to the AP 104, or vice versa.

This information indicating whether reception of TWT information frames is enabled may be indicated as a bit or field (e.g., subfield), for example, in a TWT element, high efficiency (HE) Capabilities element, Extended Capabilities element, HE Operation element, or another bit/field/subfield of a frame (e.g., a header field). The information indicating whether reception of TWT information frames is enabled may be a static property and, in some aspects when a static property, the information may be indicated in the HE Capabilities element or Extended Capabilities element.

Alternatively, the information indicating whether reception of TWT information frames is enabled may be dynamically set. For example, one of the AP 104 or the STA 114 may establish a communication link with the other of the AP 104 or the STA 114 and, while the communication link is active, the one of the AP 104 or the STA 114 may dynamically determine whether to enable or disable reception of TWT information frames. Based on the determination whether to enable or disable reception of TWT information frames, the one of the AP 104 or the STA 114 may dynamically set an indication (e.g., bit, field, subfield, etc.) of whether reception of TWT information frames is to be enabled or disabled. In some aspects when dynamically set, the information may be indicated in the TWT element or HE Operation element.

In some aspects, an apparatus (e.g., the AP 104 and/or the STA 114) may enable or disable reception of TWT information frames in association with a subset of communication and/or scheduling, rather than for all communication during all scheduling by that apparatus. Accordingly, one of the AP 104 or the STA 114 may enable or disable reception of TWT information frames in connection with one or more TWT agreements and/or according to one or more broadcast TWT schedules. For example, one of the AP 104 or the STA 114 may identify a specific TWT agreement based on one or more fields/subfields of a frame, such as a transmitter address (e.g., a medium access control (MAC) address of the one of the AP 104 or the STA 114), a receiver address (e.g., a MAC address of another one of the AP 104 or the STA 114), and a TWT Flow ID (e.g., as indicated in a bit/field/subfield of a TWT information element, a beacon frame, or similar signaling described infra). In connection with identifying a specific TWT agreement, the one of the AP 104 or the STA 114 may set a bit/field/subfield to indicate whether reception of TWT information frames is enabled or disabled for that one of the AP 104 or the STA 114 in that specific TWT agreement. Similarly, one of the AP 104 or the STA 114 may identify a specific broadcast TWT schedule based on one or more fields/subfields of a frame, such as a transmitter address (e.g., the MAC address of the one of the AP 104 or the STA 114) and a broadcast TWT ID (e.g., as indicated in a bit/field/subfield of a TWT information element, a beacon frame, or similar signaling described infra). In connection with identifying a specific broadcast TWT schedule, the one of the AP 104 or the STA 114 may set a bit/field/subfield to indicate whether reception of TWT information frames is enabled or disabled for that one of the AP 104 or the STA 114 during that specific broadcast TWT schedule.

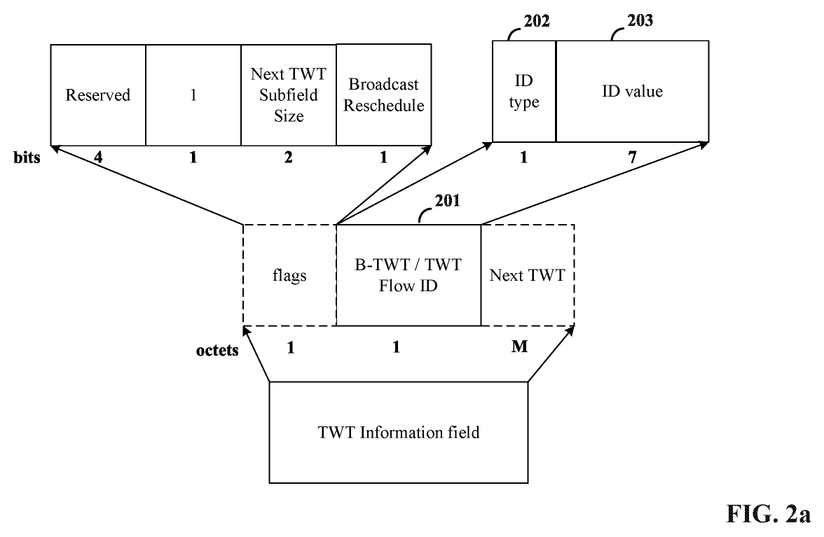

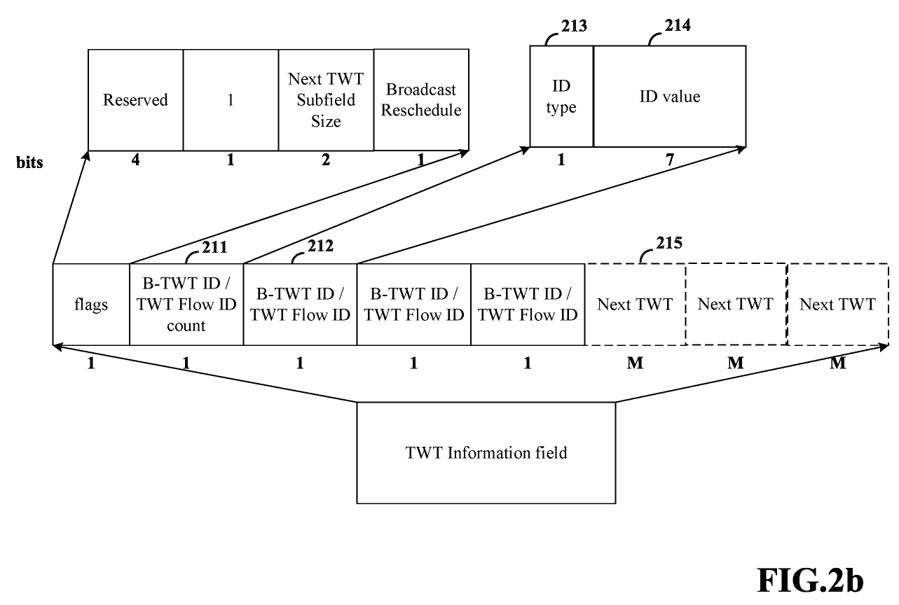

FIG. 2a shows an example format of the TWT information field of a TWT information frame to support the suspension or resumption of one broadcast-TWT session or one individual-TWT session in accordance with techniques described herein. In FIG. 2a, the AP 104 may make format changes to the existing TWT information field to support a broadcast-TWT ID or an individual-TWT ID. The TWT Flow ID bit and the Response Requested bit (not shown) of the TWT information field are reserved and the Nest TWT Request bit (not shown) is set to 1 to indicate the new format. A new B-TWT ID/TWT Flow ID subfield 201 is added. The B-TWT ID/TWT Flow ID subfield 201 has an ID type bit 202 to indicate whether the ID value 203 is for a broadcast-TWT ID or an individual-TWT flow ID. In one aspect, the flow ID may apply to broadcast-TWT flow ID so that it may represent the broadcast-TWT session that has the specified flow ID value.

FIG. 2b shows an example format of the TWT information field of a TWT information frame to support the suspension or resumption of multiple broadcast-TWT sessions or multiple individual-TWT sessions in accordance with techniques described herein. In FIG. 2b, format changes are made to the TWT information field to support multiple broadcast-TWT IDs or multiple individual-TWT ID. The AP 104 may add a B-TWT ID/Flow ID count subfield 211 to represent the number of broadcast-TWT sessions or individual-TWT sessions supported by the TWT information field. The B-TWT ID/Flow ID count subfield 211 may be one-byte long. Multiple bytes of B-TWT ID/TWT Flow ID 212 are allocated, one for each broadcast-TWT session or individual-TWT session supported. The B-TWT ID/TWT Flow ID 212 represents the broadcast-TWT ID or the individual-TWT flow ID of a TWT session. The B-TWT ID/TWT Flow ID subfield 212 has an ID type bit 213 to indicate whether the ID value 214 is for a broadcast-TWT ID or an individual-TWT flow ID. Multiple fields of Next TWT 215 are used to resume or suspend one or more of the multiple broadcast-TWT sessions with one TWT information frame. The k-th Next TWT 215 corresponds to the k-th B-TWT ID/TWT Flow ID 212, The multiple Next TWT 215 and the multiple B-TWT ID/TWT Flow ID 212 apply also to individual-TWT sessions so that multiple individual-TWT sessions may be resumed or suspended with one TWT information frame.

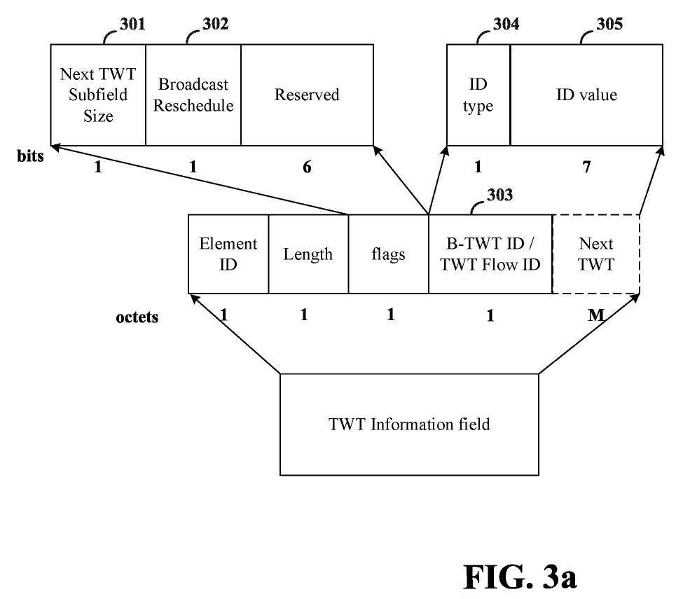

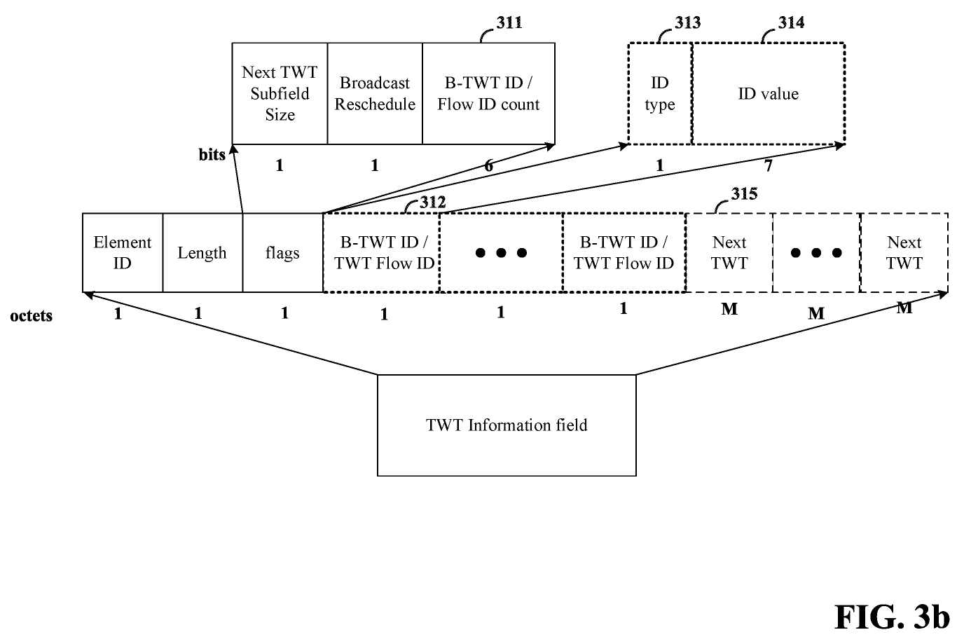

FIG. 3a shows an example format of the TWT information element of a TWT information frame to support the suspension or resumption of one broadcast-TWT session or one individual-TWT session in accordance with techniques described herein. A new element is added to the TWT information element to support a broadcast-TWT ID or an individual-TWT ID. In one aspect, the “Next TWT Subfield Size” bit 301 and “Broadcast Reschedule” bit 302 remain the same. The AP 104 may add a “B-TWT ID/TWT Flow ID” subfield 303. The B-TWT ID/TWT Flow ID subfield 303 has an ID type bit 304 to indicate whether the ID value 305 is for a broadcast-TWT ID or an individual-TWT flow ID. In one aspect, the flow ID may apply to broadcast-TWT flow ID so that it may represent the broadcast-TWT session that has the specified flow ID value.

FIG. 3b shows an example format of the TWT information element of a TWT information frame to support the suspension or resumption of multiple broadcast-TWT sessions or multiple individual-TWT session in accordance with techniques described herein. A new element is added to the TWT information element to support multiple broadcast-TWT IDs or multiple individual-TWT ID. The AP may reserve 6 bits in the flags as a B-TWT ID/Flow ID count subfield 311 to represent the number of broadcast-TWT sessions or individual-TWT sessions supported by the TWT information element. Multiple bytes of B-TWT ID/TWT Flow ID subfield 312 follow the B-TWT ID/Flow ID count subfield 311, one for each broadcast-TWT session or individual-TWT session supported. The B-TWT ID/TWT Flow ID subfield 312 represents the broadcast-TWT ID or the individual-TWT flow ID of a TWT session. The B-TWT ID/TWT Flow ID subfield 312 has an ID type bit 313 to indicate whether the ID value 314 is for a broadcast-TWT ID or an individual-TWT flow ID. Multiple fields of Next TWT 315 are used to resume or suspend one or more of the multiple broadcast-TWT sessions with one TWT information frame. The k-th Next TWT 315 corresponds to the k-th B-TWT ID/TWT Flow ID subfield 312, The multiple Next TWT 315 and the multiple B-TWT ID/TWT Flow ID subfield 312 apply also to individual-TWT sessions so that multiple individual-TWT sessions may be resumed or suspended with one TWT information frame.

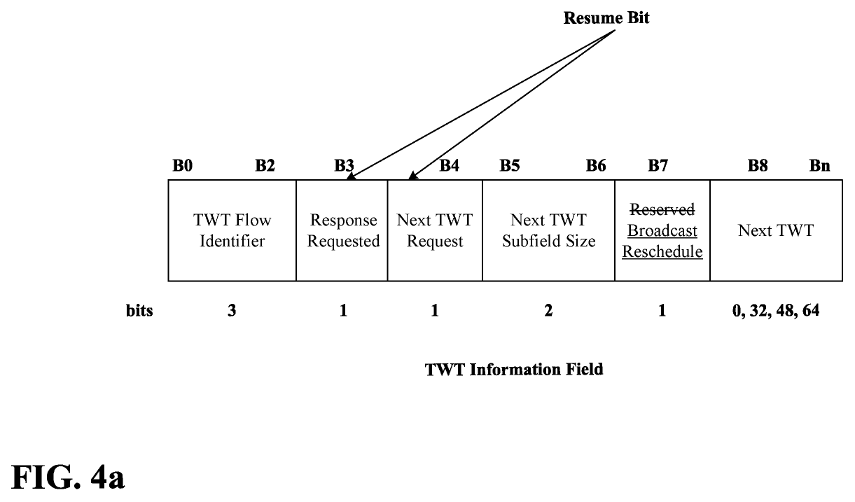

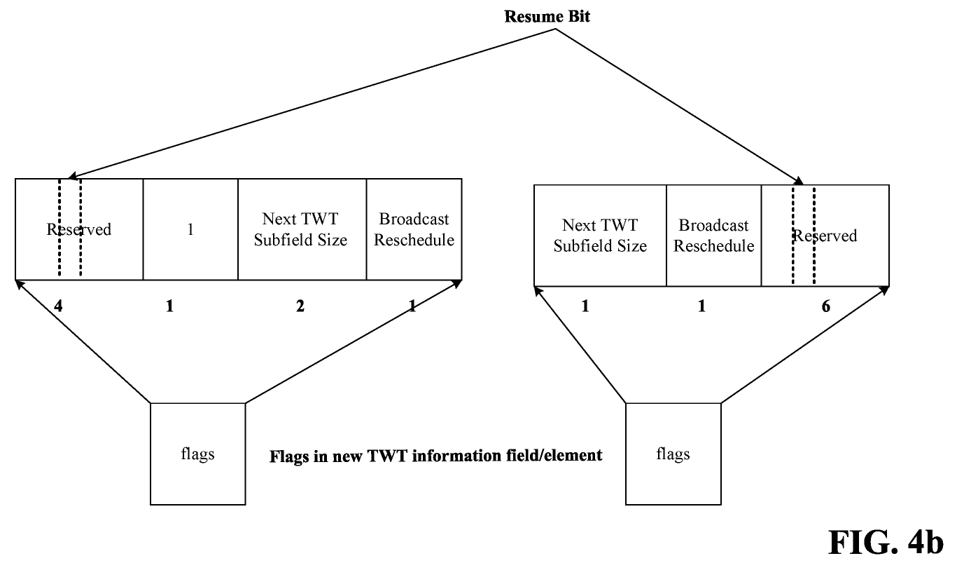

FIG. 4a shows an example format of using one reserved/unused bits of current TWT information field of a TWT information frame to support the suspension or resumption of broadcast-TWT membership in accordance with techniques described herein. Suspend/resume B-TWT membership both use TWT information field/element in TWT information frame. Next TWT is not used in directed TWT information frame for B-TWT because Next TWT is for all STAs participated in this session. Target Wake Time in Beacon may dictate when the SPs will be resumed. To differentiate whether the frame is for suspension or resumption, one bit is used. In the current TWT information field, the “Response Requested” or “next TWT Requested” bit is used.

FIG. 4b shows an example format of using one reserved/unused bits of new TWT information element of a TWT information frame to support the suspension or resumption of broadcast-TWT membership in accordance with techniques described herein. To differentiate whether the frame is for suspension or resumption, one bit is used. For the new TWT information field/element, one bit in the reserved subfield may be used.

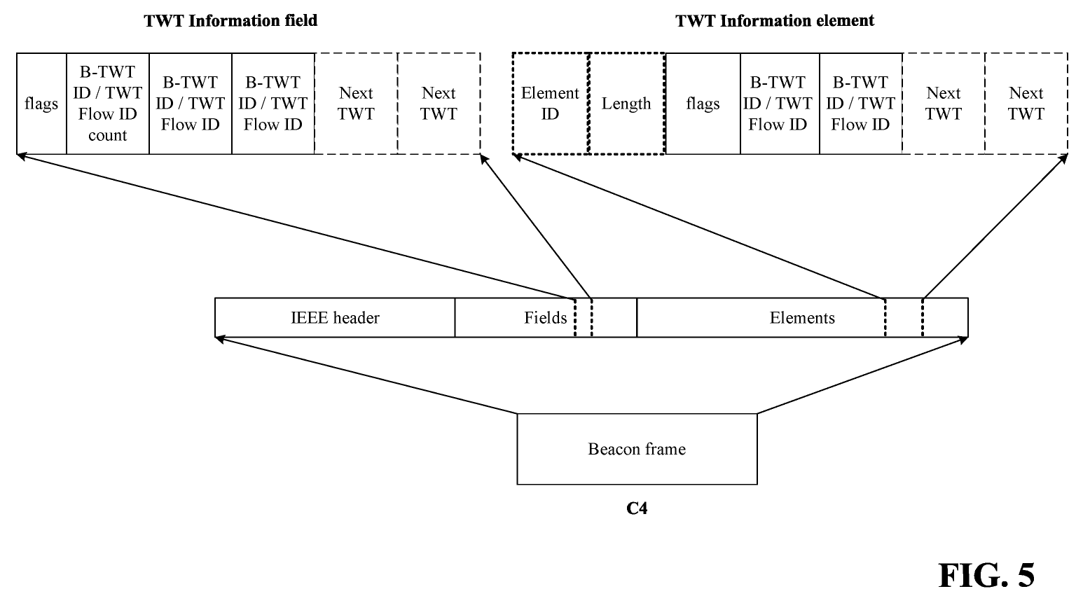

FIG. 5 shows an example format of the TWT information field or TWT information element of a TWT beacon frame to support the suspension or resumption of multiple broadcast-TWT sessions for all member STAs of the sessions in accordance with the techniques described herein. The TWT information field or TWT information element in beacon is used so that entire B-TWT session can be suspended/resumed. Existing implementation allows only TWT element in beacons to setup broadcast-TWT session. FIG. 5 adds the TWT information field to the beacon frame to support the suspension or resumption of multiple broadcast-TWT sessions for all member STAs of the sessions. In this way, suspension/resumption entire B-TWT session from AP may be implemented to support off-channel operation. Although FIG. 5 shows a beacon frame, in other aspects, another frame may be used without departing from the scope of the present disclosure. For example, rather than a beacon frame, any broadcast frame may be used, and such a broadcast frame may be sent to all STAs having membership in a particular broadcast-TWT session. An example of another frame besides a beacon frame may be a broadcast TWT information frame.

The behavior of using the format changes to resume or suspend multiple broadcast-TWT or multiple individual-TWT session is now explained. In one aspect, STA can suspend/resume 1, N or all I-TWT sessions or/and B-TWT membership. When resuming, there is no Next TWT in TWT info field/element, and the STA may use the Target Wake Time in TWT element of beacons. In one aspect, the AP may suspend/resume 1, N or all I-TWT sessions or/and B-TWT sessions with all STAs. When resuming, every session will have its corresponding Next TWT in the TWT info field/element. To suspend/resume all I-TWT efficiently, “Broadcast Reschedule” is extended to apply to I-TWT as well so that it does not only apply to B-TWT sessions. If the “Broadcast Reschedule” bit is set to 1 in the TWT info field/element, all B-TWT and I-TWT sessions/membership may be suspended/resumed.

In one aspect, when the Broadcast Reschedule bit is set to 1 and the number of B-TWT ID/TWT Flow ID is set to 0, all individual-TWT sessions or membership of all broadcast-TWT sessions for one STA may be suspended or resumed depending on whether the resume bit is set or not. In this aspect, the number of Next TWT is set to zero in the TWT information field or in the TWT information element in the TWT information frame sent by the STA. In one aspect, when the Broadcast Reschedule bit is set to 0 and the number of B-TWT ID/TWT Flow ID is set to N, N individual-TWT sessions and membership of all broadcast-TWT sessions for one STA may be suspended or resumed depending on whether the resume bit is set or not. In this aspect, the number of Next TWT is also set to zero in the TWT information field or in the TWT information element in the TWT information frame sent by the STA.

In one aspect, when the Broadcast Reschedule bit is set to 1 and the number of B-TWT ID/TWT Flow ID is set to 0, and the number of Next TWT is set to 0 in the TWT information field or the TWT information element in the beacon sent by the AP, all broadcast-TWT sessions for all STAs may be suspended. In one aspect, when the Broadcast Reschedule bit is set to 1 and the number of B-TWT ID/TWT Flow ID is set to 0, and the number of Next TWT is set to N in the TWT information field or the TWT information element in the beacon sent by the AP, all broadcast-TWT sessions for all STAs may be resumed.

In one aspect, when the Broadcast Reschedule bit is set to 0 and the number of B-TWT ID/TWT Flow ID is set to N, and the number of Next TWT is set to 0 in the TWT information field or the TWT information element in the beacon sent by the AP, N broadcast-TWT sessions for all STAs may be suspended. In one aspect, when the Broadcast Reschedule bit is set to 0 and the number of B-TWT ID/TWT Flow ID is set to N, and the number of Next TWT is set to N in the TWT information field or the TWT information element in the beacon sent by the AP, N broadcast-TWT sessions for all STAs may be resumed.

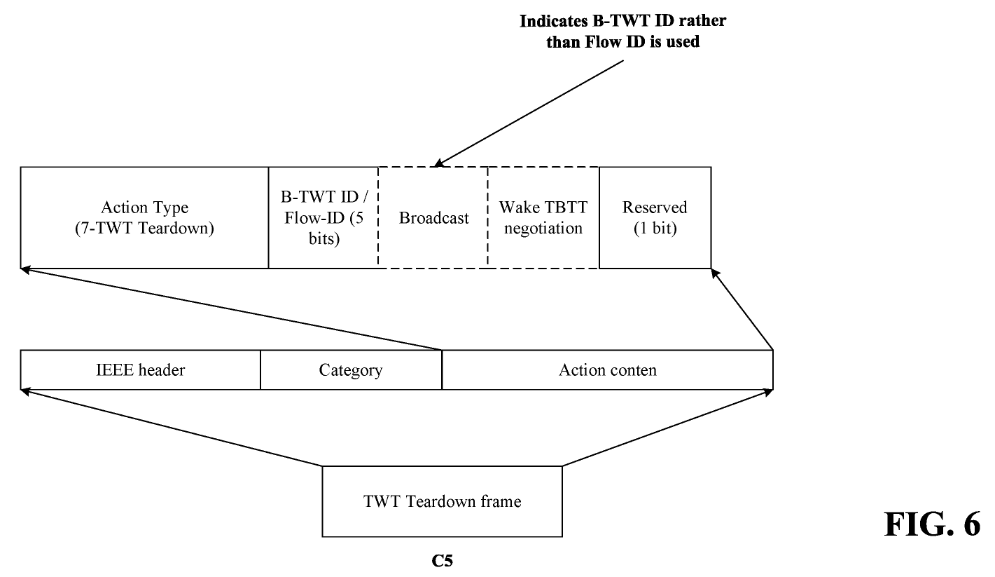

FIG. 6 shows an example format of a TWT teardown frame to support the teardown of a broadcast-TWT session accordance with the techniques described herein. The TWT teardown frame is conventionally allows only the individual-TWT flow to be used to teardown an individual-TWT session. In FIG. 6, the teardown frame is modified to use one reserved bit to indicate that the B-TWT ID is targeted instead of individual-TWT Flow ID. An additional reserved bit is used to indicate the B-TWT ID is for B-TWT session or Wake TBTT Negotiation. With this change, B-TWT membership or Wake TBTT Negotiation can be easily torn down. In one aspect, when the B-TWT ID bit is set to 0 and the Wake TBTT Negotiation bit is set to 0, the individual-TWT session having the flow ID specified by the B-TWT ID/Flow-ID field of the TWT teardown frame is torn down. In one aspect, when the B-TWT ID bit is set to 0 and the Wake TBTT Negotiation bit is set to 1, this is not a set of valid parameters. In one aspect, when the B-TWT ID bit is set to 1 and the Wake TBTT Negotiation bit is set to 0, membership in the broadcast-TWT session having the broadcast-TWT ID specified by the B-TWT ID/Flow-ID field is torn down. In one aspect, when the B-TWT ID bit is set to 1 and the Wake TBTT Negotiation bit is set to 1, Wake TBTT negotiation for the broadcast-TWT session having the broadcast-TWT ID specified by the B-TWT ID/Flow-ID field is torn down.

According to various aspects, the two bits (e.g., one bit to indicate that the B-TWT ID is targeted instead of individual-TWT Flow ID, and one bit to indicate the B-TWT ID is for B-TWT session or Wake TBTT Negotiation) may be included in separate fields (e.g., one bit in the Broadcast field, and another bit in the Reserved field). However, these two bits may be combined into a single field containing two or more bits, such as the Broadcast field or another field. In one aspect in which these two bits are combined into a single field, the single field may be associated with a different name, such as “Negotiation Type.”

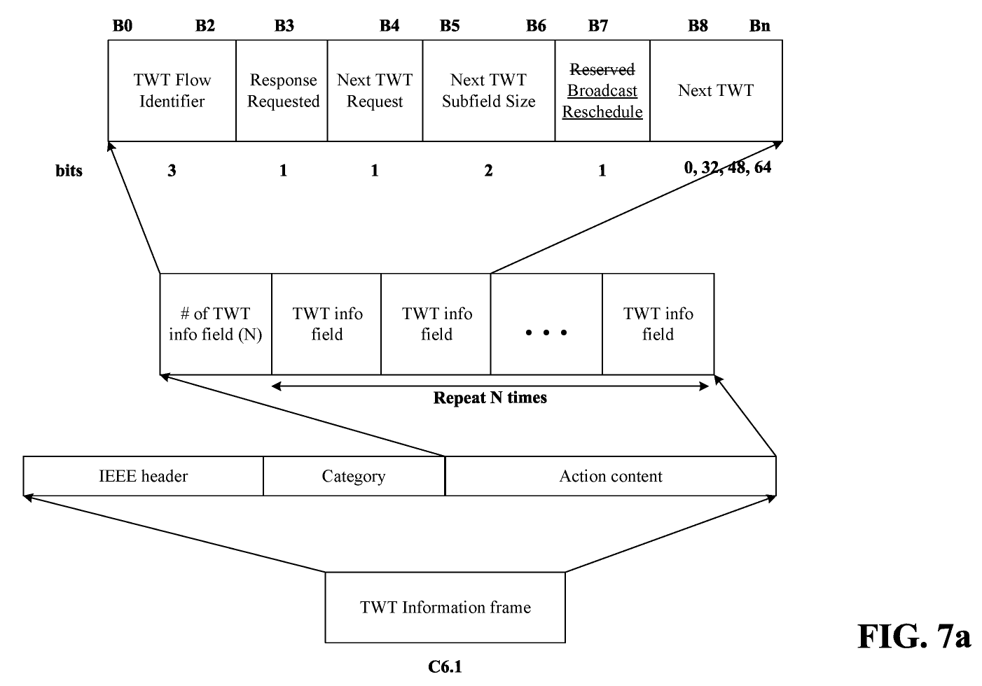

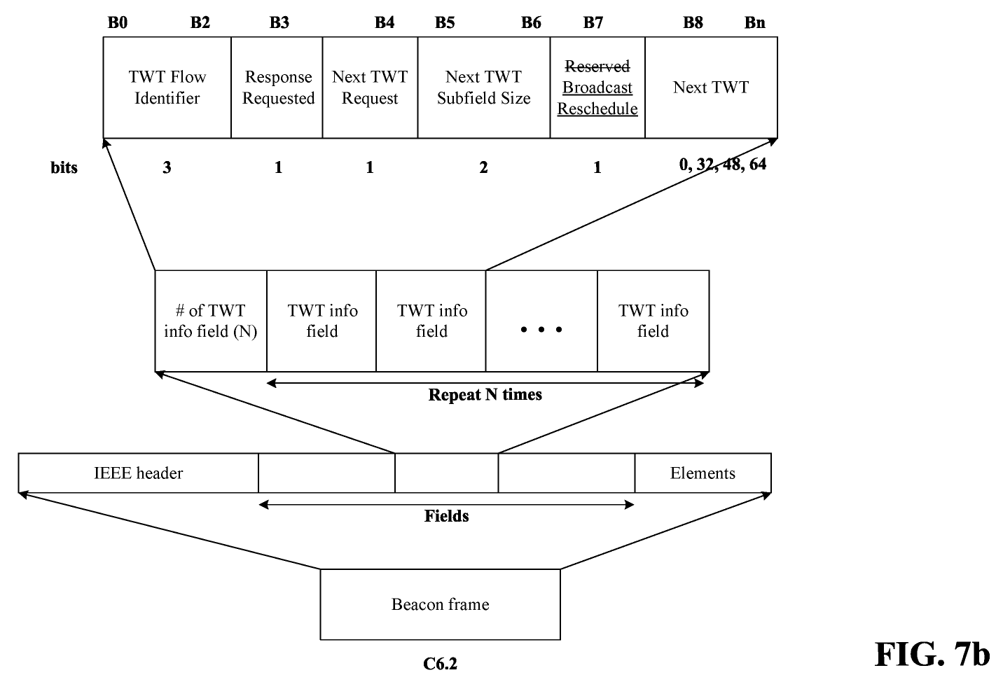

FIG. 7a shows an example format of multiple TWT information fields of a TWT information frame to support the suspension or resumption of multiple broadcast-TWT sessions or multiple individual-TWT sessions in accordance with the techniques described herein. Existing TWT information frame only allows one TWT information field. In FIG. 7a, to support multiple broadcast-TWT ID/Flow ID in one TWT information frame, multiple TWT information fields are allowed in the TWT information frame. A “Number of TWT information field” subfield is added to specify how many TWT information fields are present. For example, the “Number of TWT information field may be set to N to indicate there are N TWT information fields to follow in the TWT information frame. In one aspect, the TWT information frame may be used by the STA to support the suspension or resumption of multiple broadcast-TWT sessions or multiple individual-TWT sessions.

FIG. 7b shows an example format of multiple TWT information fields of a TWT beacon frame to support the suspension or resumption of multiple broadcast-TWT sessions or multiple individual-TWT sessions in accordance with the techniques described herein. In FIG. 7b, to support multiple broadcast-TWT ID/Flow ID in one TWT beacon frame, multiple TWT information fields are allowed in the TWT beacon frame. A “Number of TWT information field” subfield is added to specify how many TWT information fields are present. For example, the “Number of TWT information field may be set to N to indicate there are N TWT information fields to follow in the TWT information frame. In one aspect, the TWT beacon frame may be used by the AP to support the suspension or resumption of multiple broadcast-TWT sessions or multiple individual-TWT sessions.

In one aspect, the STA may use the format change to the TWT information field of a TWT information frame to suspend, resume 1, N, or all individual-TWT sessions or 1, N, or all broadcast-TWT sessions. For example, when the Broadcast Reschedule bit is set to 1 and the number of TWT information field is set to 1 in the TWT information field, and the Next TWT is not present, all individual-TWT session or membership of all broadcast-TWT sessions for one STA may be suspended. In one aspect, when the Broadcast Reschedule bit is set to 1 and the number of TWT information field is set to 1 in the TWT information field, and the next TWT is present, all individual-TWT session or membership of all broadcast-TWT sessions for one STA may be resumed.

In one aspect, when the Broadcast Reschedule bit is set to 0 and the number of TWT information field is set to N in the TWT information field, and the Next TWT is not present, N individual-TWT sessions or membership of N broadcast-TWT sessions for one STA may be suspended. In one aspect, when the Broadcast Reschedule bit is set to 1 and the number of TWT information field is set to N in the TWT information field, and the next TWT is present, N individual-TWT sessions or membership of N broadcast-TWT sessions for one STA may be resumed.

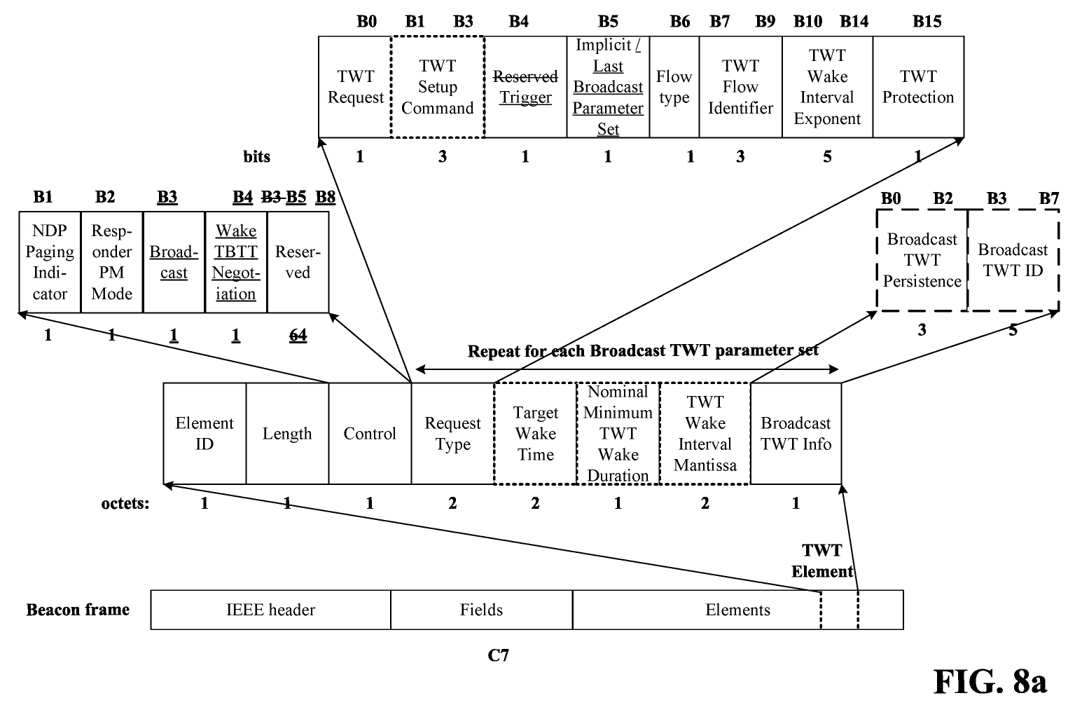

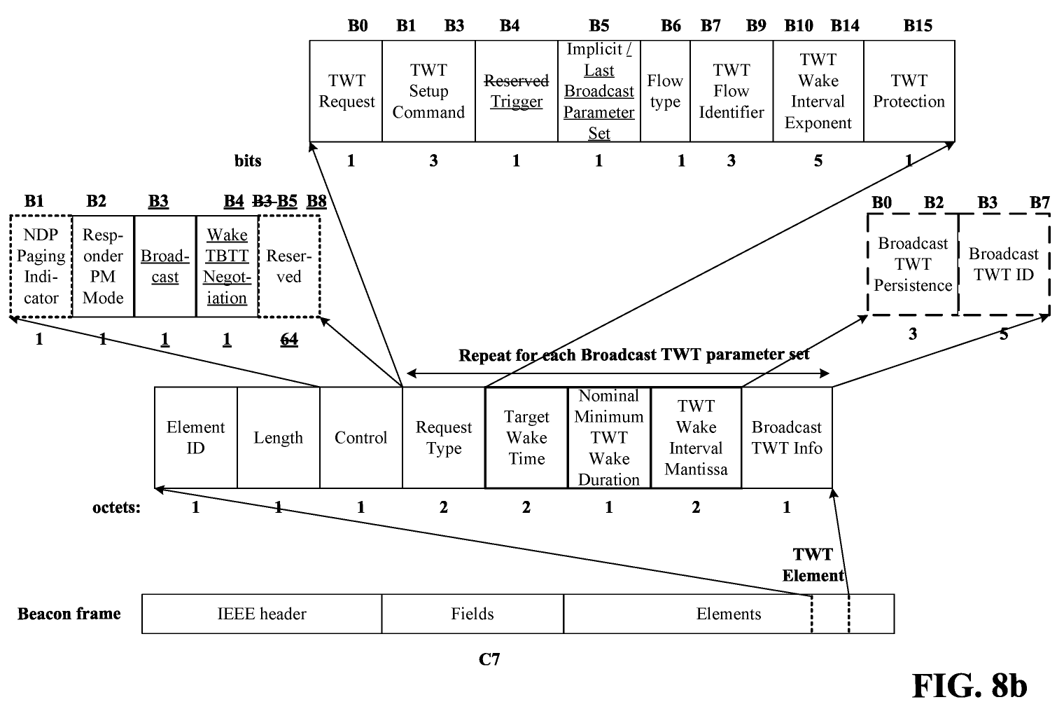

FIG. 8a shows an example format of using the TWT element in a beacon frame to support the suspension of one broadcast-TWT session in accordance with the techniques described herein. Conventionally, the TWT element of the TWT information frame is used to announce TWT sessions. In FIG. 8a, a TWT parameter value is used to indicate suspension or resumption of the broadcast-TWT session. The Target Wake Time byte may be set to 0, the Nominal Minimum TWT Wake Duration byte may be set to 0, and the TWT setup command field may be set to alternate or grouping. The Broadcast TWT Persistence field may be used to indicate when the session will be suspended, and to ensure that all STAs get notification of suspension through mandatory reception of the beacon that indicates the suspension.

FIG. 8b shows an example format of using an All Session bit of a TWT information element in a bacon frame to support the suspension or resumption of all broadcast-TWT sessions in accordance with the techniques described herein. In FIG. 8b, in order to suspend all TWT sessions efficiently, a new “All Sessions” bit in the Control Subfield may be introduced. In one aspect, one of the reserved 4 bits may be used for the “All Sessions” bit. In another aspect, the NDP Paging Indicator bit, which is not used in 802.11ax, may be used for the “All Sessions” bit. As such, only one broadcast-TWT parameter set is needed for all TWT-sessions. The “All Sessions” bit may be used to specify the suspension or resumption of all broadcast-TWT sessions in accordance with the value of the TWT bit. For example, when the TWT bit is set to 0, the “All Sessions” bit may be used to suspend all broadcast-TWT sessions. When the TWT bit is set to 1, the “All Sessions” bit may be used to resume all broadcast-TWT sessions. Although the illustrated “All Sessions” bit may be used for suspension/resumption of broadcast TWT sessions (and, potentially, individual TWT sessions), the same “All Sessions” bit or another (e.g., new) similar “All Sessions” bit may be used for teardown of all individual and/or broadcast TWT sessions.

In one aspect, the AP may use the format change to the TWT information field of a TWT information frame to suspend, resume 1, N, or all broadcast-TWT sessions. For example, when the All Session bit is set to 1 and the number of broad-cast TWT parameter set is 1 in the TWT information field, and the Target Wake Time in the TWT element in the beacon sent by the AP is 0, all broadcast-TWT sessions for all STAs may be suspended. In one aspect, when the All Session bit is set to 1 and the number of broad-cast TWT parameter set is 1 in the TWT information field, and the Target Wake Time in the TWT element in the beacon sent by the AP is 1, all broadcast-TWT sessions for all STAs may be resumed.

In one aspect, when the All Session bit is set to 0 and the number of broad-cast TWT parameter set is N in the TWT information field, and the Target Wake Time in the TWT element in the beacon sent by the AP is 0, N broadcast-TWT sessions for all STAs may be suspended. In one aspect, when the All Session bit is set to 0 and the number of broad-cast TWT parameter set is N in the TWT information field, and the Target Wake Time in the TWT element in the beacon sent by the AP is 1, N broadcast-TWT sessions for all STAs may be resumed.

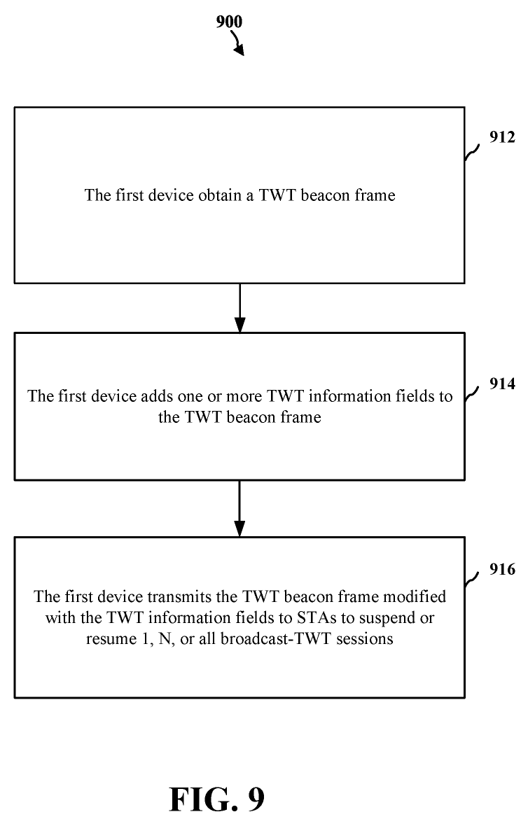

FIG. 9 is a flowchart showing an example method 900 practiced by a first device to suspend or resume multiple broadcast-TWT sessions for all member STAs of the sessions using a TWT beacon frame in accordance with the techniques described herein. The first device may be the AP. In block 912, the AP obtains a TWT beacon frame. In block 914, the first device adds one or more TWT information fields to the TWT beacon frame. In block 916, the first device transmits the TWT beacon frame modified with the TWT information fields to member STAs of the broadcast-TWT sessions to suspend or resume 1, N, or all the broadcast-TWT sessions.

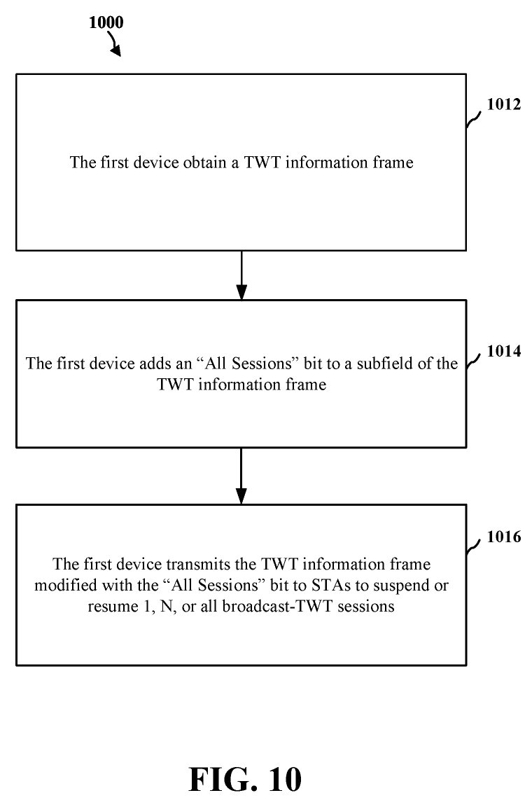

FIG. 10 is a flowchart showing an example method 1000 practiced by a first device to suspend or resume multiple broadcast-TWT sessions for all member STAs of the sessions using the TWT information element of a TWT information frame in accordance with the techniques described herein. The first device may be the AP. In block 1012, the AP obtains a TWT information frame. In block 1014, the first device adds an “All Sessions” bit to a subfield of the TWT information frame. The subfield may be the Control subfield of the TWT information frame. In block 1016, the first device transmits the TWT information frame modified with the All Sessions bit to member STAs of the broadcast-TWT sessions to suspend or resume 1, N, or all the broadcast-TWT sessions.

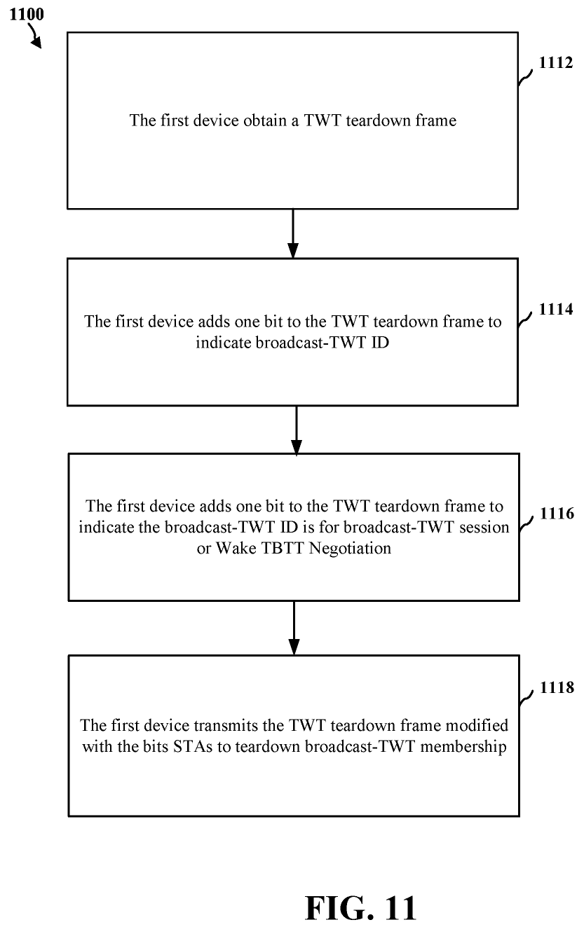

FIG. 11 is a flowchart showing an example method 1100 practiced by a first device to teardown a broadcast-TWT session using a TWT teardown frame in accordance with the techniques described herein. The first device may be the AP. In block 1112, the AP obtains a TWT teardown frame. In block 1114, the first device adds an one bit to the TWT teardown frame to indicate the broadcast-TWT ID instead of the individual-TWT flow ID. In block 1116, the first device adds another bit to the TWT teardown frame to indicate whether the broadcast-TWT ID is used for broadcast-TWT session or for Wake TBTT negotiation. In block 1118, the first device transmits the TWT teardown frame modified with the added bits set to the desired value to member STAs of the broadcast-TWT sessions to tear down the broadcast-TWT membership.

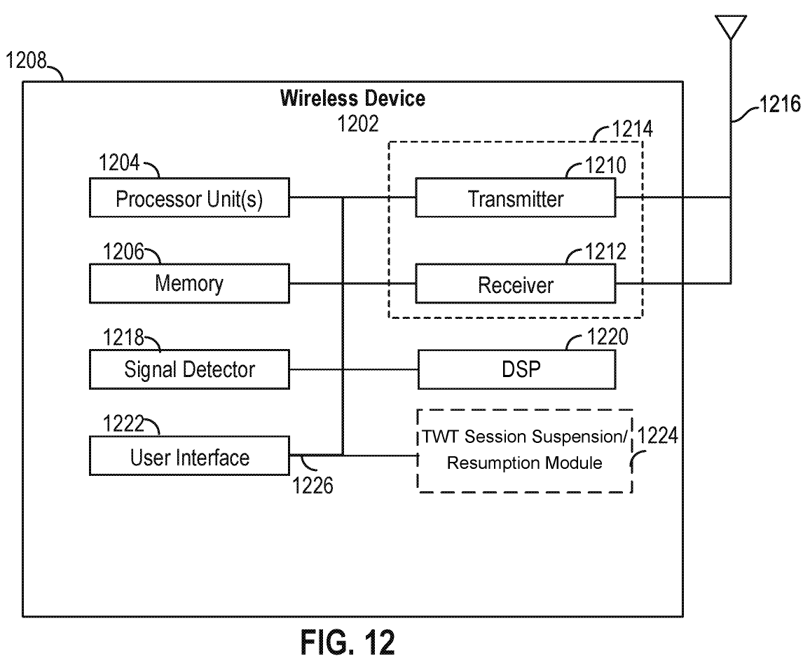

FIG. 12 shows a functional block diagram of an example wireless device 1202 configured in accordance with the techniques described herein. The wireless device 1202 is an example of a device that may be configured to implement the various methods described herein. For example, the wireless device 1202 may comprise an AP (e.g., the AP 104) or a STA (e.g., STA 114). The wireless device 1202 may be configured to perform the techniques recited by the claims or any combination of the claims.

The wireless device 1202 may include a processor 1204 which controls operation of the wireless device 1202. The processor 1204 may also be referred to as a central processing unit (CPU). Memory 1206, which may include both read-only memory (ROM) and random access memory (RAM), may provide instructions and data to the processor 1204. A portion of the memory 1206 may also include non-volatile random access memory (NVRAM). The processor 1204 typically performs logical and arithmetic operations based on program instructions stored within the memory 1206. The instructions in the memory 1206 may be executable (by the processor 1204, for example) to implement the methods described herein.

The processor 1204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 1202 may also include a housing 1208, and the wireless device 1202 may include a transmitter 1210 and/or a receiver 1212 to allow transmission and reception of data between the wireless device 1202 and a remote device. The transmitter 1210 and the receiver 1212 may be combined into a transceiver 1214. An antennas 1216 having multiple sectors may be attached to the housing 1208 and electrically coupled to the transceiver 1214. The wireless device 1202 may also include multiple transmitters, multiple receivers, multiple transceivers, and/or multiple antennas.

The wireless device 1202 may also include a signal detector 1218 that may be used to detect and quantify the level of signals received by the transceiver 1214 or the receiver 1212. The signal detector 1218 may detect such signals as total energy, energy per subcarrier per symbol, power spectral density, SNR, and other signals. The wireless device 1202 may also include a DSP 1220 for use in processing signals. The DSP 1220 may be configured to generate a packet for transmission. In some aspects, the packet may comprise frames that contain the power constraint information.

The wireless device 1202 may further comprise a user interface 1222 in some aspects. The user interface 1222 may comprise a keypad, a microphone, a speaker, and/or a display. The user interface 1222 may include any element or component that conveys information to a user of the wireless device and/or receives input from the user.

When the wireless device 1202 is implemented as an AP (e.g., the AP), the wireless device 1002 may comprise a TWT session suspension/resumption module 1024. The TWT session suspension/resumption module 1024 may be configured to suspend, teardown, resume member STAs of the broadcast-TWT session using the TWT beacon frames.

The various components of the wireless device 1202 may be coupled together by a bus system 1226. The bus system 1226 may include a data bus, for example, as well as a power bus, a control signal bus, and a status signal bus in addition to the data bus. Components of the wireless device 1202 may be coupled together or accept or provide inputs to each other using some other mechanism.

Although a number of separate components are illustrated in FIG. 12, one or more of the components may be combined or commonly implemented. For example, the processor 1204 may be used to implement not only the functionality described herein with respect to the processor 1004, but also to implement the functionality described herein with respect to the signal detector 1218, the DSP 1220, the user interface 1222, and the TWT session suspension/resumption module 1024. Further, each of the components shown and described with reference to FIG. 12 may be implemented using a plurality of separate elements.

Moreover, means for performing the various functions described herein may include the processor/processing unit(s) 1204, the transmitter 1210, the receiver 1212, the signal detector 1218, the TWT session suspension/resumption module 1024, and/or one or more other components described with respect to FIG. 1.

The various operations of methods described herein may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described herein without departing from the scope of the claims.

Further disclosure is included in the Appendix.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. For example, even though the pre-association TPC is described for a WiFi network, the aspects described may be applied to other wireless networks, such as a cellular network. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method to suspend or resume one or more target wake time (TWT) sessions by a first device of a wireless communication network, comprising:
obtaining a TWT frame;
adding one or more TWT information fields or information elements to the TWT frame; and
transmitting the TWT frame to a second device to suspend or resume a selectable number of a plurality of TWT sessions on the first device or the second device.

2. The method of claim 1, wherein the one or more TWT information fields or information elements comprise one or more subfields, wherein a number of the one or more subfields corresponds to the selectable number of the plurality of TWT sessions to suspend or resume on the first device or the second device.

3. The method of claim 1, wherein the one or more TWT information fields or information elements comprise a subfield to indicate to the first device or the second device to suspend or resume all of the plurality of TWT sessions.

4. The method of claim 1, wherein the first device is a user equipment (UE) and the second device is an access point (AP) of the wireless communication network, wherein transmitting the TWT frame comprises the UE transmitting the TWT frame to the AP to indicate to the AP that the UE is suspending or resuming a selectable number of a plurality of individual TWT (I-TWT) sessions or a selectable number of memberships of a plurality of broadcast TWT (B-TWT) sessions.

5. The method of claim 4, wherein the one or more TWT information fields or information elements comprise a subfield that indicates to the AP whether the UE is resuming the selectable number of the plurality of TWT sessions or the UE is suspending the selectable number of the plurality of TWT sessions.

6. The method of claim 5, further comprising:
receiving a second frame from the AP to indicate one or more times to resume a corresponding one of the selectable number of the plurality of TWT sessions if the subfield indicates that the UE is resuming the selectable number of the plurality of TWT sessions.

7. The method of claim 1, wherein the first device is an access point (AP) and the second device is one of a plurality of user equipment (UE), wherein transmitting the TWT frame comprises the AP transmitting the TWT frame to the plurality of UE to indicate to the plurality of UE that the AP is suspending or resuming a selectable number of a plurality of broadcast TWT (B-TWT) sessions for all UE that are members of a selectable number of the plurality of B-TWT sessions.

8. The method of claim 7, wherein the one or more TWT information fields or information elements comprise a first subfield that indicates to the plurality of UE whether the AP is resuming the selectable number of the plurality of B-TWT sessions or the AP is suspending the selectable number of the plurality of B-TWT sessions.

9. The method of claim 8, wherein the one or more TWT information fields or information elements comprise one or more of a second set of subfields that indicate one or more times to resume a corresponding one of the selectable number of the plurality of B-TWT sessions for all UE that are members of one of the plurality of B-TWT sessions if the first subfield indicates that the AP is resuming the selectable number of the plurality of B-TWT sessions.

10. The method of claim 7, wherein transmitting the TWT frame comprises the AP transmitting the TWT frame containing the one or more TWT information fields or information elements in a broadcast frame.

11. The method of claim 10, wherein the broadcast frame comprises a beacon frame.

12. The method of claim 1, wherein the first device is an access point (AP) and the second device is a user equipment (UE), wherein transmitting the TWT frame comprises the AP transmitting the TWT frame to the UE to indicate to the UE that the AP is suspending or resuming a selectable number of a plurality of individual TWT (I-TWT) sessions for the UE.

13. A method to teardown one or more target wake time (TWT) sessions by a first device of a wireless communication network, comprising:
obtaining a TWT frame;
adding one or more subfields to the TWT frame; and
transmitting the TWT frame to a second device to teardown a selectable number of a plurality of TWT sessions or a selectable number of a plurality of wake target beacon transmission time (TBTT) negotiations on the second device.

14. The method of claim 13, wherein the one or more subfields comprise:
a first subfield to indicate that the first device is tearing down the selectable number of a plurality of individual TWT (I-TWT) sessions or the selectable number of a plurality of broadcast TWT (B-TWT) sessions;
a second subfield to indicate that the first device is tearing down a selectable number of the plurality of B-TWT sessions or a selectable number of the plurality of wake TBTT negotiations.

15. The method of claim 13, wherein the one or more subfields comprise a subfield to indicate that the first device is tearing down all of the plurality of TWT sessions.

16. A first device, comprising:
at least one processor; and
at least one memory communicatively coupled with the at least one processor and storing processor readable code that, when executed by the at least one processor, causes the first device of a wireless communication network to:
obtain a TWT frame;
add one or more TWT information fields or information elements to the TWT frame; and
transmit the TWT frame to a second device to suspend or resume a selectable number of a plurality of TWT sessions on the first device or the second device.

17. The first device of claim 16, wherein the one or more TWT information fields or information elements comprise one or more subfields, wherein a number of the one or more subfields corresponds to a selectable number of the plurality of TWT sessions to suspend or resume on the first device or the second device.

18. The first device of claim 16, wherein the one or more TWT information fields or information elements comprise a subfield to indicate to the first device or the second device to suspend or resume all of the plurality of TWT sessions.

19. The first device of claim 16, wherein the first device is a user equipment (UE) and the second device is an access point (AP) of the wireless communication network, wherein to transmit the TWT frame comprises the UE is configured to transmit the TWT frame to the AP to indicate to the AP that the UE is suspending or resuming a selectable number of a plurality of individual TWT (I-TWT) sessions or a selectable number of memberships of a plurality of broadcast TWT (B-TWT) sessions.

20. The first device of claim 19, wherein the one or more TWT information fields or information elements comprise a subfield that indicates to the AP whether the UE is resuming the selectable number of the plurality of TWT sessions or the UE is suspending the selectable number of the plurality of TWT sessions.

21. The first device of claim 20, wherein the at least one processor when executing the processor readable code causes the first device to:
receive a second frame from the AP to indicate one or more times to resume a corresponding one of the selectable number of the plurality of TWT sessions if the subfield indicates that the UE is resuming the selectable number of the plurality of TWT sessions.

22. The first device of claim 16, wherein the first device is an access point (AP) and the second device is one of a plurality of user equipment (UE), wherein to transmit the TWT frame comprises the AP is configured to transmit the TWT frame to the plurality of UE to indicate to the plurality of UE that the AP is suspending or resuming a selectable number of a plurality of broadcast TWT (B-TWT) sessions for all UE that are members of a selectable number of the plurality of B-TWT sessions.

23. The first device of claim 22, wherein the one or more TWT information fields or information elements comprise a first subfield that indicates to the plurality of UE whether the AP is resuming the selectable number of the plurality of B-TWT sessions or the AP is suspending the selectable number of the plurality of B-TWT sessions.

24. The first device of claim 23, wherein the one or more TWT information fields or information elements comprise one or more of a second set of subfields that indicate one or more times to resume a corresponding one of the selectable number of the plurality of B-TWT sessions for all UE that are members of one of the plurality of B-TWT sessions if the first subfield indicates that the AP is resuming the selectable number of the plurality of B-TWT sessions.

25. The first device of claim 22, wherein the AP is configured to transmit the TWT frame containing the one or more TWT information fields or information elements in a broadcast frame.

26. The first device of claim 25, wherein the broadcast frame comprises a beacon frame.

27. The first device of claim 16, wherein the first device is an access point (AP) and the second device is a user equipment (UE), wherein to transmit the TWT frame comprises the AP is configured to transmit the TWT frame to the UE to indicate to the UE that the AP is suspending or resuming the selectable number of a plurality of individual TWT (I-TWT) sessions for the UE.

28. A first device, comprising:
at least one processor; and
at least one memory communicatively coupled with the at least one processor and storing processor readable code that, when executed by the at least one processor, causes the first device to:
obtain a TWT frame;
add one or more subfields to the TWT frame; and
transmit the TWT frame to a second device to teardown a selectable number of a plurality of TWT sessions or a selectable number of a plurality of wake target beacon transmission time (TBTT) negotiations on the second device.

29. The first device of claim 28, wherein the one or more subfields comprise:
a first subfield to indicate that the first device is tearing down a selectable number of a plurality of individual TWT (I-TWT) sessions or a selectable number of a plurality of broadcast TWT (B-TWT) sessions;
a second subfield to indicate that the first device is tearing down the selectable number of the plurality of B-TWT sessions or the selectable number of the plurality of wake TBTT negotiations.

30. The first device of claim 29, wherein the one or more subfields comprise a subfield to indicate that the first device is tearing down all of the plurality of I-TWT sessions and the plurality of B-TWT sessions.
